(19) United States
(12) Patent Application Publication
(10) Pub. No.: US 2014/0125879 A1
(43) Pub. Date: May 8, 2014

(54) IN-CELL TOUCH DISPLAY AND ELECTRONIC APPARATUS THEREOF

(71) Applicant: INNOLUX CORPORATION, MIAO-LI COUNTY (TW)

(72) Inventors: YU MEI CHIU, YILAN COUNTY (TW); YU CHENG TSAI, CHANGHUA COUNTY (TW); CHAO LIANG LU, MIAOLI COUNTY (TW)

(73) Assignee: INNOLUX CORPORATION, MIAO-LI COUNTY (TW)

(21) Appl. No.: 14/058,783

(22) Filed: Oct. 21, 2013

(30) Foreign Application Priority Data
Nov. 7, 2012 (TW) 101141301

(51) Int. Cl. G02F 1/1333

(52) U.S. Cl. CPC G02F 1/13338
USPC 349/12

(57) ABSTRACT

An in-cell touch display has a thin-film-transistor substrate, and the thin-film-transistor has a first transparent substrate, a touch sensor layer and a thin-film transistor circuit layer. The touch sensor layer is formed on the first transparent substrate, and has a plurality of parallel first electrode lines and a plurality of parallel second electrode lines. The first electrode lines and the second electrode lines are vertical to and insulated from each other. The thin-film-transistor circuit layer is insulated from the touch sensor layer, wherein at least a portion of the touch sensor layer is located in the thin-film-transistor layer, or the touch sensor layer is located under the thin-film-transistor layer. The thin-film transistor circuit layer has a plurality of parallel data lines and a plurality of parallel gate lines, and the data lines and the gate lines are vertical to and insulated from each other.

### BACKGROUND

1. Technical Field

The present disclosure relates to a touch display, in particular, to an in-cell touch display and an electronic apparatus thereof.

2. Description of Related Art

Conventional touch displays are almost out-cell touch displays. The out-cell touch display is formed by a touch control panel and a liquid crystal display panel, thus having at least three glass layers. Therefore, the out-cell touch display is heavy and thick, and does not meet the trend that the electronic product should be thin, short, light, and small.

Additionally, someone currently proposes a structure of an in-cell touch display in which a touch sensor layer is directly embedded in a liquid crystal display panel. However, since the touch sensor layer is directly embedded in the liquid crystal display panel, touch control sensing signals on touch control sensing lines and touch control driving signals on touch control driving lines may be interfered by signals in the liquid crystal display panel, such that a control unit at a rear end may mistakenly decide a touch position, and the electronic apparatus may work mistakenly.

### SUMMARY

An exemplary embodiment of the present disclosure provides an in-cell touch display comprising a thin-film-transistor substrate, and the thin-film-transistor comprises a first transparent substrate, a touch sensor layer and a thin-film transistor circuit layer. The touch sensor layer is formed on the first transparent substrate, and has a plurality of parallel first electrode lines and a plurality of parallel second electrode lines. The first electrode lines and the second electrode lines are vertical to and insulated from each other. The thin-film-transistor circuit layer is formed on the first transparent substrate and insulated from the touch sensor layer, wherein at least one portion of the touch sensor layer is located in the thin-film-transistor layer, or the touch sensor layer is located under the thin-film-transistor layer. The thin-film transistor circuit layer has a plurality of parallel data lines and a plurality of parallel gate lines, and the data lines and the gate lines are vertical to and insulated from each other.

An exemplary embodiment of the present disclosure provides an electronic apparatus comprising an electronic apparatus body and the in-cell touch display mentioned above, wherein the in-cell touch display is electrically connected to the electronic apparatus body.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a schematic diagram showing a stack structure of an in-cell touch display according to an exemplary embodiment of the present disclosure.

FIG. 2 is a planar diagram of an in-cell touch display according to an exemplary embodiment of the present disclosure.

FIG. 3 is a schematic diagram showing a stack structure of an in-cell touch display according to another exemplary embodiment of the present disclosure.

FIG. 4 is a schematic diagram showing a stack structure of an in-cell touch display according to another exemplary embodiment of the present disclosure.

FIG. 5 is a planar diagram of an in-cell touch display according to another exemplary embodiment of the present disclosure.

FIG. 6 is a schematic diagram showing a stack structure of an in-cell touch display according to another exemplary embodiment of the present disclosure.

FIG. 7 is a planar diagram of an in-cell touch display according to another exemplary embodiment of the present disclosure.

FIG. 8 is a schematic diagram showing a stack structure of an in-cell touch display according to another exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

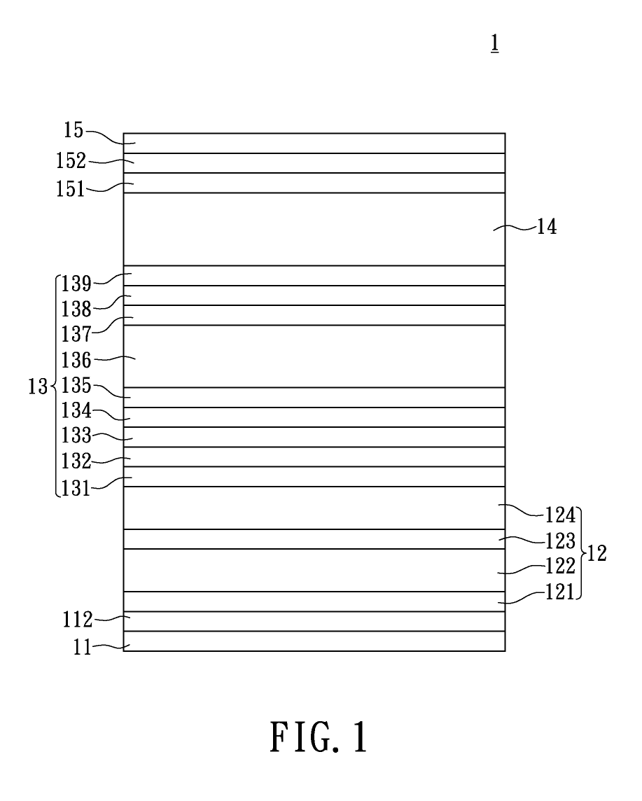

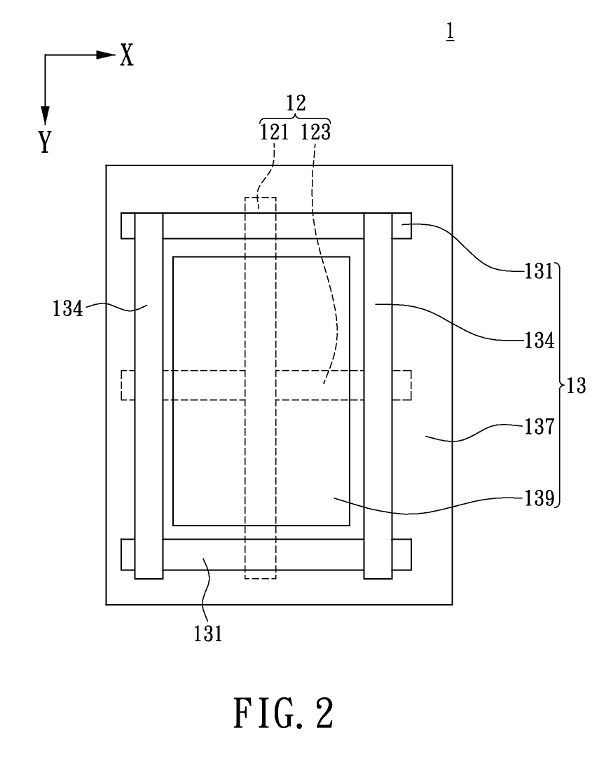

Referring to FIG. 1 and FIG. 2, FIG. 1 is a schematic diagram showing a stack structure of an in-cell touch display according to an exemplary embodiment of the present disclosure, and FIG. 2 is a planar diagram of an in-cell touch display according to an exemplary embodiment of the present disclosure. The in-cell touch display 1 comprises a thin-film-transistor substrate (comprising a first transparent substrate 11, a touch sensor layer 12, and a thin-film transistor circuit layer 13), a liquid crystal layer 14, a second transparent substrate 15, and a backlight (not shown in FIG. 1 and FIG. 2). The touch sensor layer 12 is located on the first transparent substrate 11, and the thin-film transistor circuit layer 13 is entirely located on the touch sensor layer 12 (i.e. the touch sensor layer 12 is located under the thin-film transistor circuit layer 13). The liquid crystal layer 14 is located on the thin-film transistor circuit layer 13, the second transparent substrate 15 is located on the liquid crystal layer 14, and the backlight is located on the second transparent substrate 15. When using the in-cell touch display 1, the in-cell touch display 1 must be put upside down, i.e. the first transparent substrate 11 faces to the user, and the second transparent substrate 15 is used to receive the light from the backlight.

In the exemplary embodiment, the first transparent substrate 11 can be glass substrate, and a black matrix layer 112 can be further set on the first transparent substrate 11. The black matrix layer 112 is used to prevent the reflecting light from the metal in the touch sensor layer 12 or the thin-film transistor circuit layer 13, so as to enhance the display screen quality. Regardless of the display screen quality, the black matrix layer 112 can be removed. If the material of metal is lower reflection, black matrix layer 112 can be reduced. In addition, the glass substrate can be replaced by the other transparent insulation substrate, such as a polyethylene terephthalate (PET) substrate. In short, the implementation of the first transparent substrate 11 is not intended to limit the present disclosure.

The touch sensor layer 12 comprises a plurality of first electrode lines 121, a first insulation layer 122, a plurality of second electrode lines 123, and a second insulation layer 124. The first insulation layer 122 is located between the first electrode lines 121 and the second electrode lines 123, such that the first electrode lines 121 and the second electrode lines 123 are insulated from each other. The second insulation layer 124 is located on the second electrode lines 123, such that the touch sensor layer 12 and the thin-film transistor circuit layer 13 are insulated from each other.

As shown in FIG. 2, the second electrode lines 123 are arranged parallel to each other and along with a first axis (such as X axis), and the first electrode lines 121 are arranged parallel to each other and along with a second axis (such as Y axis). The first axis is vertical to the second axis, and thus the first electrode lines 121 and the second electrode lines 123 can form a plurality of mutual capacitances, and the control unit at a rear end can detect the changes of the mutual capacitances formed by the first electrode lines 121 and the second electrode lines 123 to determine a touch position.

Still referring to FIG. 1 and FIG. 2, in the exemplary embodiment of the present disclosure, the first electrode lines 121 and the second electrode lines 123 can be implemented by transparent conduction lines or metal lines, and the black matrix layer 112 located on the first transparent substrate 11 can be used to prevent the light reflection, but the present disclosure is not limited thereto. Furthermore, to enhance the precision of the touch sensing, the first electrode lines 121 and the second electrode lines 123 are preferably touch control sensing lines and touch control driving lines respectively, but the present disclosure is not limited thereto. In other words, the first electrode lines 121 and the second electrode lines 123 can be preferably touch control driving lines and touch control sensing lines respectively alternatively, and the touch control driving lines are located on the touch control sensing lines (i.e. compared to the touch control driving lines, the touch control sensing lines are more closed to the first transparent substrate 11).

The thin-film transistor circuit layer 13 comprises a plurality of gate lines 131, a gate insulation layer 132, a channel layer 133, a plurality of data lines 134, a first protection layer 135, a filling layer 136, a common electrode 137, a second protection layer 138, and a plurality of pixel electrodes 139. The gate insulation layer 132 is located on the gate lines 131, thus insulating the gate lines from the channel layer 133. The channel layer 133 is located on the gate insulation layer 132, the data lines 134 are located on the channel layer 133, and the first protection layer 135 is located on the data lines 134. The filling layer 136 is located on the first protection layer 135, and the common electrode 137 is located on the filling layer 136. The second protection layer 138 is located on the common electrode 137, and the pixel electrodes 139 are located on the second protection layer 138.

As shown in FIG. 2, the gate lines 131 are arranged parallel to each other and along with the first axis (such as X axis), and the data lines 134 are arranged parallel to each other and along with the second axis (such as Y axis). The filling layer 136 is used to boost the thin-film transistor circuit layer 13, and has a smoothing function. In the exemplary embodiment, the filling layer 136 can be selectively removed. In addition, the positions of the pixel electrodes 139 and the common electrode 137 can be exchanged.

In the exemplary embodiment, the backlight can be a light source of a cold cathode fluorescent lamp (CCFL) or a light emission diode (LED), and the black matrix layer 152 and the color filter 151 are sequentially set under the second transparent substrate 15 correspondingly, wherein the second transparent substrate 15 can be a glass substrate, but the present disclosure is not limited thereto. The black matrix layer 152 is located on the color filter 151, and the second transparent substrate 15 is located on the black matrix layer 152. To put it concretely, the black matrix layer 152 is located on the display region and/or the peripheral region of the second transparent substrate 15, wherein black matrix layer 152 on the display region is corresponding to the channel layer 133, such that the leakage current due to the light of the backlight emitting on the channel layer 133 is avoided.

Regardless the display performance, the black matrix layer 152 can be removed. In addition, when the backlight comprises light source of the red, green, and blue organic LED (OLED), the color filter 151 can be corresponding removed. Furthermore, the second transparent substrate 15 can be replaced by the other transparent insulation substrate, such as the PET substrate. In short, the implementation of the second transparent substrate 15 is not used to limit the present disclosure. Moreover, the common electrode 137 can be removed from the thin-film transistor circuit layer 13, and independently set between the liquid crystal layer 14 and the second transparent substrate 15.

In the exemplary embodiment, since the touch sensor layer 12 is located on the first transparent substrate 11, the effect which the liquid field interferes the touch sensor layer 12 is reduced. Therefore, the precision of touch control sensing is enhanced, and the uneven lightness problem caused by that the touch control field interferes the liquid crystal deflection is also solved. Moreover, since the touch sensor layer 12 and the thin-film transistor circuit layer 13 are separated from each other and not located at the same layer, the thin-film transistor circuit layer 13 of the in-cell touch display 1 can be manufactured by using the present thin-film transistor process.

In addition, in the exemplary embodiment of FIG. 2, the first electrode lines 121 bypass the data lines 134 in the planar view, and the second electrode lines 123 bypass the gate lines 131 in the planar view, so as to reduce the effect which the display signal interferes the touch control sensing signals and the touch control driving signals, for example, the effect may result a parasitic capacitance. However, it is noted that the design that the first electrode lines 121 bypass the data lines 134 in the planar view, and the second electrode lines 123 bypass the gate lines 131 in the planar view is not used to limit the present disclosure. For example, the first electrode lines 121 or the second electrode lines 123 may overlap the data lines 134 or the gate lines 131 in the planar view.

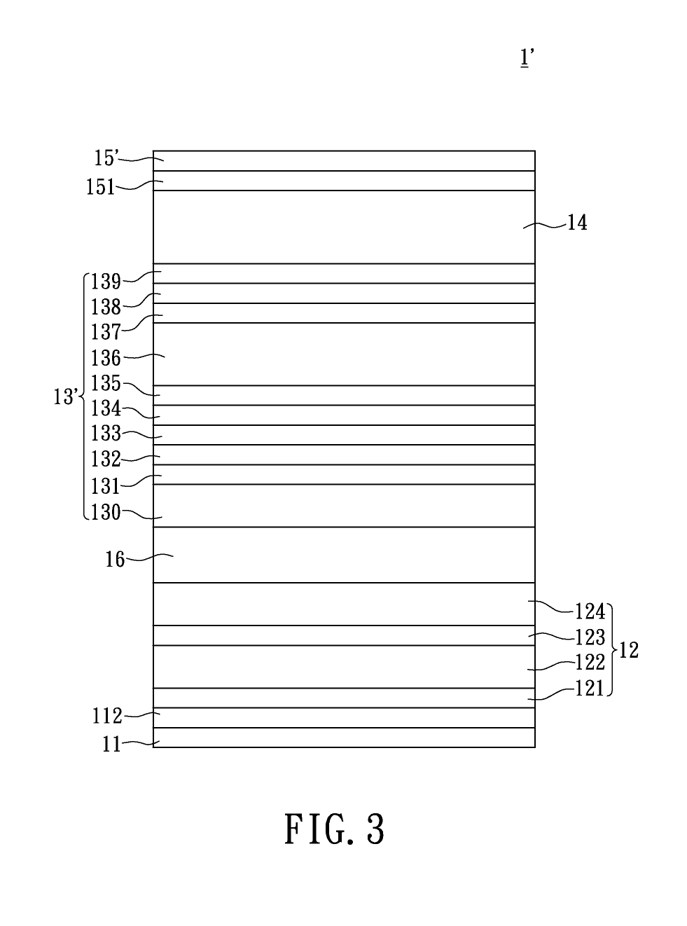

Referring to FIG. 3, FIG. 3 is a schematic diagram showing a stack structure of an in-cell touch display according to another exemplary embodiment of the present disclosure. Compared to the in-cell touch display 1 in FIG. 1, the in-cell touch display 1′ in FIG. 3 has a shield metal layer 16 set between the thin-film transistor circuit layer 13′ and the touch sensor layer 12, thus preventing the signal interference between the touch sensor layer 12 and the thin-film transistor circuit layer 13′ and enhancing the precision of touch control sensing of the in-cell touch display 1′.

Furthermore, since the shield metal layer 16 is set between the thin-film transistor circuit layer 13′ and the touch sensor layer 12, compared to the thin-film transistor circuit layer 13 in FIG. 1, the thin-film transistor circuit layer 13′ further has a third insulation layer 130 located between the gate lines 131 and the shield metal layer 16 to insulate the shield metal layer 16 from the gate lines 131. Moreover, in the exemplary embodiment, the black matrix layer 152 may be not set under the second transparent substrate 15′ of the in-cell touch display 1′, and another manner can be used to solve the problems of the light reflection and the light exposure on the rim edge. Alternatively, the black matrix layer 152 can be set under the second transparent substrate 15′ to solve the mentioned problems.

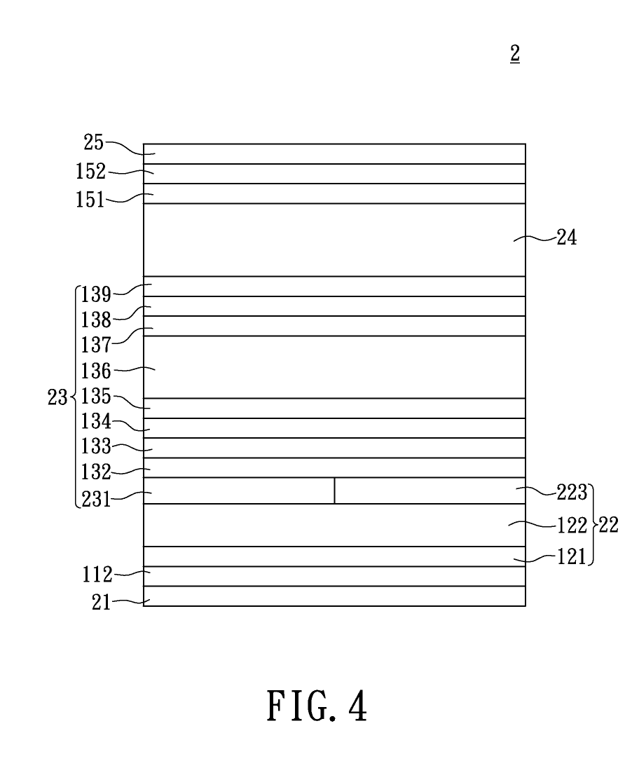

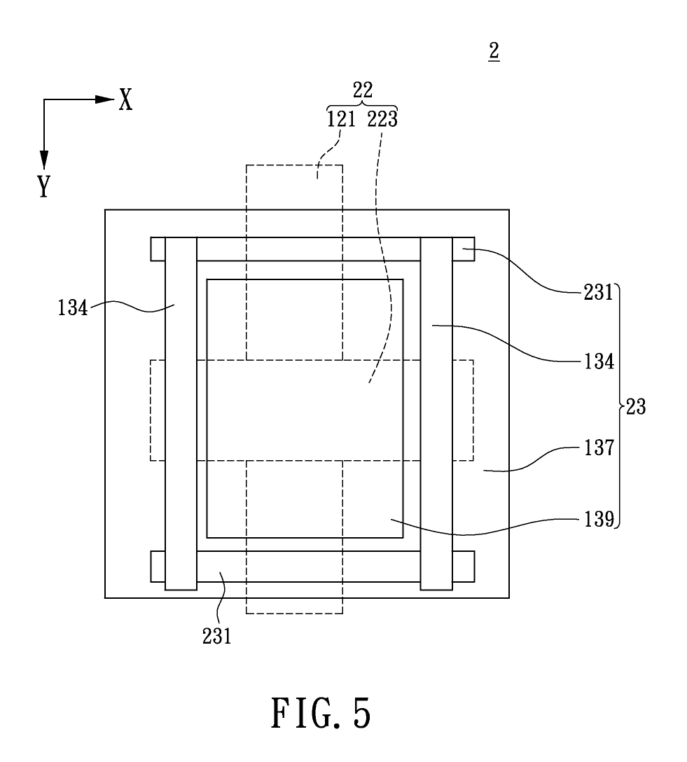

Referring to FIG. 4 and FIG. 5, FIG. 4 is a schematic diagram showing a stack structure of an in-cell touch display according to another exemplary embodiment of the present disclosure, and FIG. 5 is a planar diagram of an in-cell touch display according to another exemplary embodiment of the present disclosure. The in-cell touch display 2 comprises a thin-film-transistor substrate (comprising a first transparent substrate 21, a touch sensor layer 22, and a thin-film transistor circuit layer 23), a liquid crystal layer 24, and a second transparent substrate 25. The touch sensor layer 22 is located on the first transparent substrate 21, and at least a portion of the touch sensor layer 22 is located on the thin-film transistor circuit layer 22, and at least one portion of the thin-film transistor circuit layer 23 and the touch sensor layer 22 share at least one of the same stratums. The liquid crystal layer 24 is located on the thin-film transistor circuit layer 23, and the second transparent substrate 25 is located on the liquid crystal layer 24. When using the in-cell touch display 2, the in-cell touch display 2 must be put upside down, i.e. the first transparent substrate 21 faces to the user, and the second transparent substrate 25 is used to receive the light from the backlight.

Compared to the in-cell touch display 1 in FIG. 1, the second electrode lines 223 of the touch sensor layer 22 and the gate lines 231 of the thin-film transistor circuit layer 23 are located at a same stratum, and as shown in FIG. 4, the touch sensor layer 22 thus lacks for the second insulation layer, and the gate insulation layer 132 of the thin-film transistor circuit layer 23 is used to insulate the channel layer 132 from the second electrode lines 223 and the gate lines 231.

The second electrode lines 223 and the gate lines 231 are parallel to each other without overlapping each other on the planar view as shown in FIG. 5, i.e. the second electrode lines 223 bypass the gate lines 231 on the planar view, and are arranged parallel to each other and along with the first axis to insulate the touch sensor layer 22 from the thin-film transistor circuit layer 23.

Additionally, the other components in the touch sensor layer 22 and the thin-film transistor circuit layer 23 are described in the exemplary embodiment of FIG. 1, and thus the redundant description is omitted. The first transparent substrate 21, the black matrix layer 112, 152, the color filter 151, the liquid crystal layer 24, and the second transparent substrate 25 in FIG. 4 are respectively the same as the first transparent substrate 11, the black matrix layer 112, 152, the color filter 151, the liquid crystal layer 24, and the second transparent substrate 25 in FIG. 1, and thus the redundant description is omitted.

Since the gate lines 231 and the second electrode lines 223 share the same stratum, the thickness of the in-cell touch display 2 can be decreased, and the present thin-film transistor process can be slightly modified to manufacture the touch sensor layer 22 of the thin-film transistor circuit layer 23.

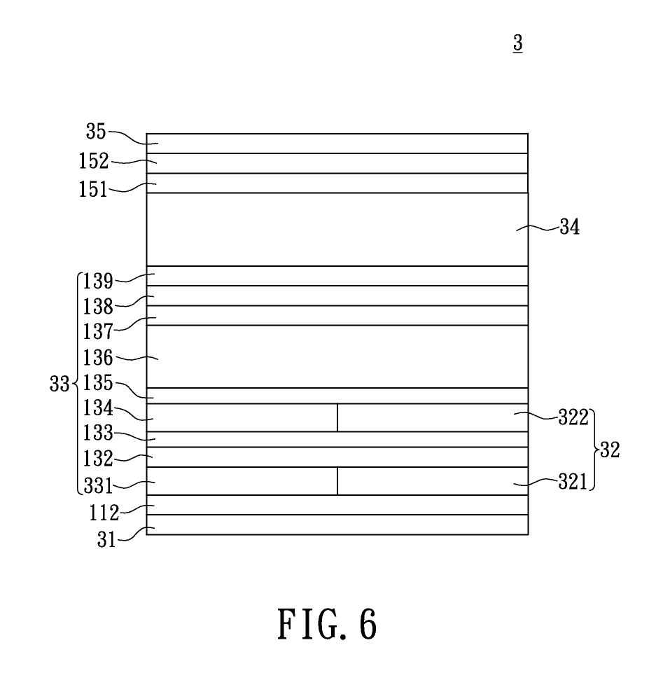

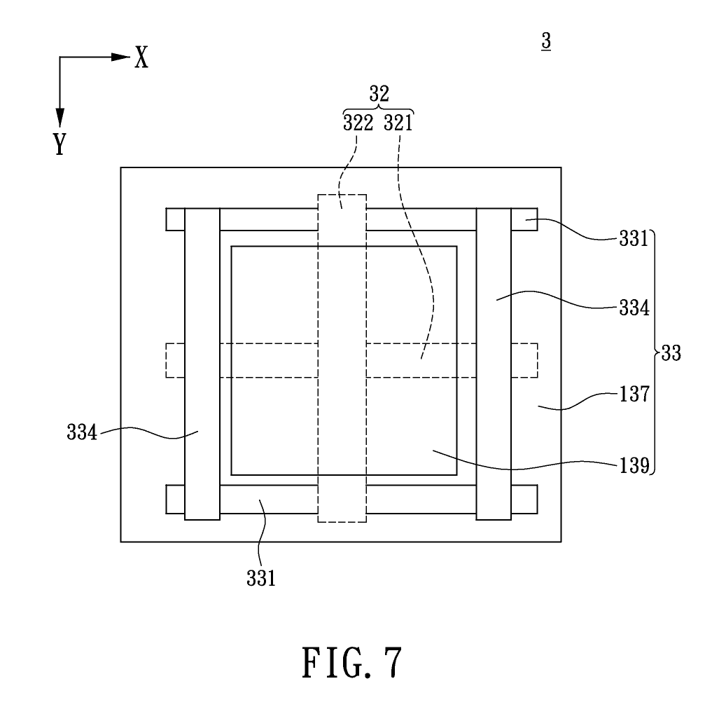

Referring to FIG. 6 and FIG. 7, FIG. 6 is a schematic diagram showing a stack structure of an in-cell touch display according to another exemplary embodiment of the present disclosure, and FIG. 7 is a planar diagram of an in-cell touch display according to another exemplary embodiment of the present disclosure. The in-cell touch display 3 comprises a thin-film-transistor substrate (comprising a first transparent substrate 31, a touch sensor layer 32, and a thin-film transistor circuit layer 33), a liquid crystal layer 34, and a second transparent substrate 35. The touch sensor layer 32 is located on the first transparent substrate 31, and at least a portion of all the touch sensor layer 32 is located in the thin-film transistor circuit layer 33, i.e. at least one portion of the thin-film transistor circuit layer 33 and the touch sensor layer 32 shares at least one of the same stratums. The liquid crystal layer 34 is located on the thin-film transistor circuit layer 33, and the second transparent substrate 35 is located on the liquid crystal layer 34. When using the in-cell touch display 3, the in-cell touch display 3 must be put upside down, i.e. the first transparent substrate 31 faces to the user, and the second transparent substrate 35 is used to receive the light from the backlight.

Compared to the in-cell touch display 1 in FIG. 1, a plurality of second electrode lines 322 of the touch sensor layer 32 and a plurality of data lines 334 of the thin-film transistor circuit layer 33 share a same stratum, and a plurality of first electrode lines 321 of the touch sensor layer 32 and a plurality of gate lines 331 of the thin-film transistor circuit layer 33 share another same stratum. Therefore, the touch sensor layer 22 lacks for a first insulation layer and a second insulation layer as shown in FIG. 6. The gate insulation layer 132 of the thin-film transistor circuit layer 33 is used to insulate the channel layer 133 from the first electrode lines 321 and the gate lines 331.

As shown in FIG. 7, the second electrode lines 322 and the data lines 334 are parallel to each other without overlapping each other on the planar view, and the first electrode lines 321 and the gate lines 331 are parallel to each other without overlapping each other on the planar view. In other words, the second electrode lines 322 bypass the data lines 334 on the planar view, and are arranged parallel to each other and along with the second axis; the first electrode lines 321 bypass the gate lines 331 on the planar view, and are arranged parallel to each other and along with the first axis. Therefore, the touch sensor layer 22 is insulated from the thin-film transistor circuit layer 23.

Moreover, the other components in the touch sensor layer 32 and the thin-film transistor circuit layer 33 are described in the exemplary embodiment of FIG. 1, and thus the redundant description is omitted. The first transparent substrate 31, the black matrix layer 112, 152, the color filter 151, the liquid crystal layer 34, and the second transparent substrate 35 in FIG. 6 are respectively that same as the first transparent substrate 11, the black matrix layer 112, 152, the color filter 151, the liquid crystal layer 14, and the second transparent substrate 15 in FIG. 1, and thus the redundant description is omitted.

Since the gate lines 331 and the first electrode lines 321 share the same stratum, and the data lines 334 and the second electrode lines 322 share the other same stratum, the thickness of the in-cell touch display 3 can be further decreased. The present thin-film transistor process can be used to manufacture the thin-film transistor circuit layer 33 and touch sensor layer 32.

The concept of the present disclosure can be applied to the active organic LED display panel (i.e. the touch sensor layer is combined into the thin-film transistor panel with the organic LED structure), the combination is almost shown in FIG. 1 through FIG. 7, and the merely difference is that the organic LED display panel does not need the liquid crystal layer, the color filter, and the backlight.

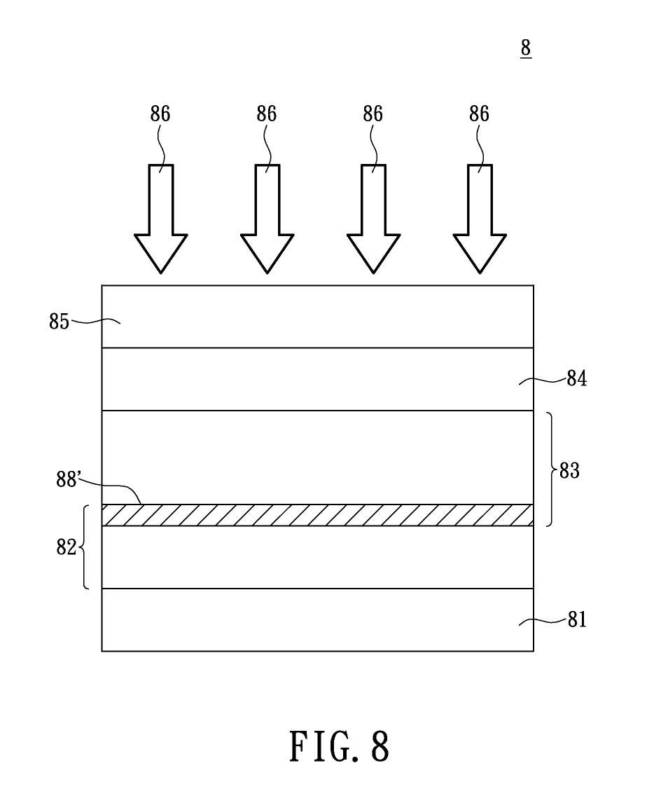

Referring to FIG. 8, FIG. 8 is a schematic diagram showing a stack structure of an in-cell touch display according to another exemplary embodiment of the present disclosure. The exemplary embodiment of the present disclosure provides an in-cell touch display 8 comprising a thin-film-transistor substrate 80, and the thin-film-transistor substrate 80 comprises a first transparent substrate 81, a touch sensor layer 82, and a thin-film transistor circuit layer 83. The touch sensor layer 82 is located on the first transparent substrate 81, and at least a portion of the thin-film transistor circuit layer 83 or the entire thin-film transistor circuit layer 83 is located on the touch sensor layer 82, i.e. the touch sensor layer 82 and the thin-film transistor circuit layer 83 has an overlapped portion 88′, or the alternatively, the overlapped portion 88′ may not exist.

The thin-film-transistor substrate 80 may further comprises a liquid crystal layer 84, a second transparent substrate 85, a backlight 86, but the present disclosure is not limited thereto. The liquid crystal layer 84 is located on the thin-film transistor circuit layer 83, the second transparent substrate 85 is located on the liquid crystal layer 84, and the backlight 86 is located on the second transparent substrate 85. When using the in-cell touch display 8, the in-cell touch display 8 must be put upside down, i.e. the first transparent substrate 81 faces to the user, and the second transparent substrate 85 is used to receive the light from the backlight 86. Since the touch sensor layer 82 is located on the first transparent substrate 81, the effect which the liquid crystal field interferes the touch sensor layer 82 is reduced, and the touch control sensing precision is enhanced.

It is noted that, each of the mentioned in-cell touch displays is installed in the electronic apparatus, and electrically connected to the electronic apparatus body. The electronic apparatus is for example a smart phone, a pad, an automated teller machine, or the other electronic apparatus with a touch display function.

In summary, the in-cell touch display provided by an exemplary embodiment of the present disclosure can reduce effect which the liquid crystal field and signals in the thin-film transistor circuit interfere the touch sensor layer, and thus the precision of the touch control sensing is enhanced. Moreover, in the other exemplary embodiment, the touch sensor layer and the thin-film transistor circuit layer share at least one of the same layers, and thus the thickness of the in-cell display can be further decreased.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. An in-cell touch display, comprising:
a thin-film-transistor substrate, comprising:
a first transparent substrate;
a touch sensor layer, formed on the first transparent substrate, comprising a plurality of parallel first electrode lines and a plurality of parallel second electrode lines, wherein the first electrode lines and the second electrode lines are vertical to and insulated from each other; and
a thin-film transistor circuit layer, located on the first transparent substrate and insulated from the touch sensor layer, wherein at least one portion of the touch sensor layer is located in the thin-film-transistor layer, the thin-film transistor circuit layer has a plurality of parallel data lines and a plurality of parallel gate lines, and the data lines and the gate lines are vertical to and insulated from each other.

2. The in-cell touch display according to claim 1, wherein at least one portion of the thin-film transistor circuit layer is located on the touch sensor layer, and the second electrode lines and the gate lines are located at a same stratum.

3. The in-cell touch display according to claim 2, wherein the first electrode lines and the data lines are located at another same stratum.

4. The in-cell touch display according to claim 1, wherein the thin-film-transistor substrate further comprises:
a black matrix layer, located between the first transparent substrate and the touch sensor layer.

5. The in-cell touch display according to claim 1, further comprising:
a liquid crystal layer, located on the thin-film-transistor substrate;
a second transparent substrate, located on the liquid crystal layer; and
a backlight, located on the second transparent substrate.

6. An in-cell touch display, comprising:
a thin-film-transistor substrate, comprising:
a first transparent substrate;
a touch sensor layer, formed on the first transparent substrate, comprising a plurality of parallel first electrode lines and a plurality of parallel second electrode lines, wherein the first electrode lines and the second electrode lines are vertical to and insulated from each other; and
a thin-film transistor circuit layer, formed on the first transparent substrate and insulated from the touch sensor layer, wherein the touch sensor layer is located under the thin-film-transistor layer, the thin-film transistor circuit layer has a plurality of parallel data lines and a plurality of parallel gate lines, and the data lines and the gate lines are vertical to and insulated from each other.

7. The in-cell touch display according to claim 6, wherein the in-cell touch display further comprises a shield metal layer located between the touch sensor layer and the thin-film transistor circuit layer, and the shield metal layer is insulated from the touch sensor layer and the thin-film transistor circuit layer.

8. An electronic apparatus, comprising:
an electronic apparatus body; and
an in-cell touch display, electrically connected to the electronic apparatus body, comprising:
a thin-film-transistor substrate, comprising:
a first transparent substrate;
a touch sensor layer, formed on the first transparent substrate, having a plurality of parallel first electrode lines arranged and a plurality of parallel second electrode lines, wherein the first electrode lines and the second electrode lines are vertical to and insulated from each other; and
a thin-film transistor circuit layer, insulated from the touch sensor layer, wherein at least a portion of the touch sensor layer is located in the thin-film-transistor layer, or the touch sensor layer is located under the thin-film-transistor layer, the thin-film transistor circuit layer has a plurality of parallel data lines and a plurality of parallel gate lines, and the data lines and the gate lines are vertical to and insulated from each other.

9. The electronic apparatus according to claim 8, wherein the thin-film transistor circuit layer is entirely located on the touch sensor layer.

10. The electronic apparatus according to claim 8, wherein the least portion of the thin-film transistor circuit layer is located on the touch sensor layer, and the second electrode lines and the gate lines are located at a same stratum.

11. The electronic apparatus according to claim 10, wherein the first electrode lines and the data lines are located at another same stratum.

12. The electronic apparatus according to claim 9, wherein the in-cell touch display further comprises a shield metal layer located between the touch sensor layer and the thin-film transistor circuit layer, and the shield metal layer is insulated from the touch sensor layer and the thin-film transistor circuit layer.

13. The electronic apparatus according to claim 9, wherein the thin-film-transistor substrate further comprises:
a black matrix layer, located between the first transparent substrate and the touch sensor layer.

14. The electronic apparatus according to claim 8, wherein the in-cell touch display further comprising:
a liquid crystal layer, located on the thin-film-transistor substrate;
a second transparent substrate, located on the liquid crystal layer; and
a backlight, located on the second transparent substrate.
